(19) United States
(12) Patent Application Publication
(10) Pub. No.: US 2012/0303645 A1
(43) Pub. Date: Nov. 29, 2012

(54) SYSTEM AND METHOD FOR EXTRACTION OF STRUCTURED DATA FROM ARBITRARILY STRUCTURED COMPOSITE DATA

(76) Inventor: Anita Kulkarni-Puranik, Maharashtra (IN)

(21) Appl. No.: 13/575,886

(22) PCT Filed: Feb. 1, 2011
(86) PCT No.: PCT/IN2011/000071

§ 371 Date: Jul. 27, 2012

(30) Foreign Application Priority Data
Feb. 3, 2010 (IN) 271/MUM/2010

(51) Int. Cl. G06F 17/30

(52) U.S. Cl. 707/756; 707/E17.005

(57) ABSTRACT

A system for extracting and consolidating unstructured data contained in a plurality of files in composite formats is disclosed. The system includes an input means which receives a plurality of files containing unstructured data in composite formats. The input means forwards the received files to an extraction means which extracts the unstructured data from the received files. The unstructured data extracted from the received files is forwarded to a conversion means which converts the unstructured data into a structured format. The structured data so produced is worked on by an interlinking means which interlinks in a controlled manner, the accessible sections of the structured data.

### FIELD OF THE INVENTION

This invention relates to the field of data processing.

Particularly, this invention relates to the field of analysis of unstructured data and extraction of structured data from unstructured, composite data.

### DEFINITIONS OF TERMS USED IN THE SPECIFICATION

The term ‘composite spreadsheet’ in this specification relates to files that contain multiple sheets which in turn contain multiple structures.

The term ‘structure’ in this specification refers to contiguous group of non empty cells that form data patterns including tables, captions, multiple lines of explanatory text, lists with a set of predetermined values and the like.

The term ‘table’ in this specification refers to a data structure that contains multiple rows and/or columns of headers and multiple rows and/or columns of data that are grouped together to indicate different levels of hierarchy or aggregations.

The term ‘composite formats’ in this specification refer to an arrangement of data structures wherein the various data structures are placed at random locations in a file and their location in the file is not predetermined.

These definitions are in addition to those expressed in the art.

### BACKGROUND OF THE INVENTION AND PRIOR ART

Spreadsheets are commonly used for the purposes of creating, storing and analyzing data. The data created and stored in spread sheets is also used for the purpose of business analysis which directly influences the process of business decision making. Spreadsheets allow users to create and analyze data on a cell by cell basis or on a file by file basis. But the difficulty associated with working on a file to file basis becomes apparent when each file contains thousands of lines of data that needs to be analyzed. The drawback of using spreadsheet application to create and analyze data is that the user is forced to carry out the analysis of data on a file to file basis since spreadsheet application supports only file based analysis.

Another drawback associated with usage of spreadsheet application is that the spreadsheet application supports only visual inspection and analysis. Spreadsheet application provides no tools or enhancements that make the task of data analysis easier and less cumbersome. The user using the spreadsheet application is forced to analyse data only by the way of visual inspection. The task of visually inspecting and analyzing data gets more complicated if there are large numbers of files and humungous amount of data to be analyzed and consolidated.

The functionalities offered by the spreadsheet application are synonymous with the functionalities offered by a data editing software. The user, as always has to read the data contained in spreadsheets during the process of data analysis, but if the data to be analyzed is present across multiple files, then the task of the user gets complicated. Since there is a limitation on the number of files a user can simultaneously look into and analyze, it is difficult to bring accuracy to the process of data analysis when data is spread across multiple spreadsheets. Data being located in multiple files and in multiple formats can also complicate the task of data analysis and inspection.

Limitations associated with usage of spreadsheets are as follows:
Analysis only by visual inspection: Normally, spreadsheets do not contain any specific data structure and are often manipulated by users according to their perception. Lack of definite structure and arbitrary manipulation creates problems in case of large scale data analysis.
Absence of metadata: Spreadsheet application does not distinguish between labels and values contained in a column. Absence of metadata means that the onus of determining the meaning of data is solely on the user.
Lack of support for composite and arbitrarily structured data: There is significant information loss if one attempts to save a composite and arbitrarily structured file as a spreadsheet. There is significant data loss if composite and arbitrarily structured files are stored in CSV (comma separated values) format.

Several techniques have been proposed in the past in order to overcome the above mentioned limitations, but even the proposed techniques have certain limitations. The proposed techniques and their corresponding limitations are explained below.
Freezing the format of data collected in spreadsheets: The limitation associated with freezing the format of the data collected in spreadsheets is that the data formats are often governed by user requirements and often user requirements vary depending upon the type of application. Therefore it is difficult to propose a standard data format that suits every application and user requirement.
Developing macros to perform cross spreadsheet access and analysis: The limitation associated with creating macros is that, macros are not a part of the standard application package and need to, be developed by the end user himself/herself. The end user may not be comfortable and proficient with creation and utilization of macros.
Creating customized software programs to manipulate larger collections of spreadsheet data: The limitation associated with creating customized software programs to manipulate spreadsheet data is that it requires lot of expertise and time.

There have been attempts in the sate of art to develop software systems and methods that provide for efficient and error free analysis of large collections of data spread across multiple spreadsheets in composite and arbitrarily structured formats. The work done in this field includes:

U.S. Pat. No. 5,272,628 teaches a method and a system for automatically aggregating tables having a variety of configurations or layouts into a single destination table. Tables having a variety of categories with multiple divisions are combined by automatically creating corresponding rows and columns in a destination table. The rows and columns are created in the destination table based on the categories and divisions present in the source table. In accordance with the teachings of the present invention, a plurality of tables is selected as input to the system. A template containing the categories to be merged is then created by the user manually or the system automatically creates such template. After template generation, the categories and divisions corresponding to the source table are automatically mapped onto the destination table based on the mapping table which includes the values identifying source table location and template location respectively.

U.S. Pat. No. 6,317,750 teaches a method for retrieving multidimensional data from a data source and displaying the retrieved data in a pre existing user interface. The method in accordance with the above mentioned United States patent involves the step of automatically propagating user created formulas so that the user does not have to re enter the formulas. In accordance with the above mentioned patent, a data representation of the multi dimensional data is sent to a query processor which creates row and column structures. The row and column structures are manipulated based on a user action such as zoom-in, zoom-out and the like and a multi dimensional data output tree showing a hierarchy of the multidimensional data. In accordance with the above mentioned United States patent there is created a blue print containing instructions on insertions and deletions to be carried out by the program associated with the pre existing user interface such as a spread sheet program. The generated blueprint is analyzed with the aid of a data presentation manipulator and manipulated data is accommodated in the user interface.

United States Patent Application No. 2006/0167911 envisages a system and a method for data pattern recognition and extraction. According to one aspect of the above mentioned United States patent application, there is provided a computer implemented method for automatically or manually configuring a data extraction from one or more input files. In accordance with the above mentioned United States patent application a user selects one or more files for data extraction. Files are assumed to contain tables and each table has a specific format. A user interface of the invention allows the user to manually specify configuration parameters for data extraction. Alternatively, the system in accordance with the above mentioned United States patent application provides a plurality of heuristics to automatically detect data extraction areas located in one or more input files. The system automatically identifies a layout type for each extraction area and generates one or more data extraction outputs according to user defined or pre configured report types.

None of the above mentioned Patent Documents have addressed the issue of discovering and extracting unstructured data contained in a plurality of files in composite formats.

Hence there is felt a need for
a system that provides for discovery of data structures in composite spreadsheets without making any assumptions about the format, layout and content of composite spreadsheets;
a system that provides for discovery of data structures corresponding to data embedded in data files including PDF files, HTML (Hyper Text Mark Up Language) files and the like;
a system that associates metadata with non empty cells of the composite spreadsheet;
a system that identifies hierarchical relationships contained in the composite spreadsheet based on pattern recognition and natural language processing;
a system that process all the information available in the composite spreadsheet including filters, cross sheet references, cross file references, captions and comments;
a system that automatically extracts unstructured data contained in several composite spreadsheets in discrete and composite formats;
a system that converts the unstructured data into a structured format;
a system that provides for conversion of unstructured data into multiple structured formats including relational data format, system defined XML (extensible mark up language) format, user defined XML format, XBRL (extensible business reporting language) format and OWL (web ontology language);
a system that provides for aggregation of structured data based on the data type associated with the structured data; and
A system that generates metadata definition from a given input file and subsequently applies the metadata definition to similar files submitted for processing.

### OBJECTS OF THE INVENTION

It is an object of the present invention to provide a system that automatically detects data structures corresponding to data embedded in composite spreadsheets.

Yet another object of the present invention is to provide a system that automatically detects data structures corresponding to data embedded in data files including PDF files, HTML files and the like.

Another object of the present invention is to provide a system that makes no assumptions but concrete analysis of the format, layout and content of composite spreadsheets.

One more object of the present invention is to provide a system that associates metadata with each non empty cell contained in the composite spreadsheet.

Yet another object of the present invention is to provide a system that identifies hierarchical relationships between the unstructured data based on pattern recognition techniques and natural language processing techniques.

One more object of the present invention is to provide a system that processes all the information available in the composite spreadsheet including filters, cross sheet references, cross file references, captions and comments.

Another object of the present invention is to provide a system that automatically extracts unstructured data contained in different spreadsheets in discrete and composite formats.

Yet another object of the present invention is to integrate similar data contained in several structures in a single file or across a group of files.

Still further object of the present invention is to provide a system that converts the unstructured data into a structured format.

Yet another object of the present invention is to provide a system that provides for conversion of unstructured data into multiple structured formats including system defined XML (extensible mark up language) format, relational data format, user defined XML format, XBRL (extensible business reporting language) and OWL (web ontology language).

Yet another object of the present invention is to provide a system that aggregates the structured data based on the data type associated with the structured data.

### SUMMARY OF THE INVENTION

In accordance with the present invention, there is provided a system for extracting and consolidating unstructured data contained in a plurality of files in composite formats.

Typically, in accordance with the present invention, the system for extracting and consolidating unstructured data contained in a plurality of files in composite formats includes an input means which has been adapted to receive a plurality of files containing unstructured data in composite formats.

Typically, in accordance with the present invention, the system for extracting and consolidating unstructured data contained in a plurality of files in composite formats includes an extraction means adapted to receive said plurality of files and extract the unstructured data from the plurality of files.

Typically, in accordance with the present invention, the system for extracting and consolidating unstructured data contained in a plurality of files in composite formats includes a conversion means which has been adapted to receive said unstructured data, and convert the unstructured data into a structured format thereby producing structured data having accessible sections.

Typically, in accordance with the present invention, the system for extracting and consolidating unstructured data contained in a plurality of files in composite formats includes an interlinking means adapted to work on the structured data having accessible sections. The interlinking means is adapted to interlink in a controlled manner, the accessible sections of the structured data and produce interlinked structured data.

Typically, in accordance with the present invention, the system for extracting and consolidating unstructured data contained in a plurality of files in composite formats includes a data aggregation means adapted to receive the interlinked structured data and aggregate, in a controlled manner, the interlinked structured data.

Typically, in accordance with the present invention, the system for extracting and consolidating unstructured data contained in a plurality of files in composite formats further includes a query interfacing means adapted to receive queries corresponding to the interlinked structured data, said query interfacing means further adapted to work on the interlinked structured data to solve the received queries and display the results corresponding to the received queries.

Typically, in accordance with the present invention, the extraction means includes a natural language processing means having predetermined natural language processing heuristics. The natural language processing means, in accordance with the present invention is adapted to analyze the unstructured data contained in the plurality of files.

Typically, in accordance with the present invention, the extraction means includes a spatial pattern recognition means having predetermined pattern recognition heuristics.

The spatial pattern recognition means, in accordance with the present invention is adapted to recognize the pattern of the unstructured data contained in the plurality of files.

Typically, in accordance with the present invention, the conversion means is adapted to convert the unstructured data into a generalized native format.

Typically, in accordance with the present invention, the conversion means is adapted to convert said unstructured data into a user defined format.

In accordance with the present invention, there is provided a method for extracting and consolidating unstructured data contained in a plurality of files in composite formats. The method in accordance with the present invention comprises the following steps:
receiving a plurality of files containing unstructured data in composite formats;
extracting unstructured data from said plurality of files;
converting said unstructured data into a structured format and producing structured data having accessible sections; and
interlinking in a controlled manner, the accessible sections of said structured data and producing interlinked structured data.

Typically, in accordance with the present invention, the method for extracting and consolidating unstructured data contained in a plurality of files in composite formats further includes the step of aggregating in a controlled manner, the interlinked structured data.

Typically, in accordance with the present invention, the method for extracting and consolidating unstructured data contained in a plurality of files in composite formats further includes the step of receiving queries corresponding to the interlinked structured data, working on the interlinked structured data to solve received queries and displaying the results corresponding to the received queries.

Typically, in accordance with the present invention, the step of extracting the unstructured data from the plurality of files further includes the step of analyzing the unstructured data using predetermined natural language processing heuristics.

Typically, in accordance with the present invention, the step of extracting the unstructured data further includes the step of recognizing the pattern of the unstructured data using predetermined spatial pattern recognition heuristics.

Typically, in accordance with the present invention, the step of converting the unstructured data into a defined, structured format further includes the step of converting said unstructured data into a generalized native format.

Typically, in accordance with the present invention, the step of converting the unstructured data into a defined, structured format further includes the step of converting said unstructured data into a user defined format.

### BRIEF DESCRIPTION OF THE ACCOMPANYING DRAWINGS

The invention will now be described in relation to the accompanying drawings, in which:

FIG. 1 illustrates a schematic of a system for extracting and consolidating unstructured data contained in a plurality of files in composite formats;

FIG. 2 illustrates a flowchart for a method of extracting and consolidating unstructured data contained in a plurality of files in composite formats;

FIG. 3 is a screen display of a composite spreadsheet containing five distinct data structures arranged in an arbitrary pattern;

FIG. 4 is a screen display of a composite spreadsheet containing seven distinct data structures;

FIG. 5 is a screen display of a composite spreadsheet containing multiple arbitrary structures and labels; and

FIG. 6 is a screen display of logical, structured data model created in accordance with the present invention.

### DETAILED DESCRIPTION OF THE INVENTION

The invention will now be described with reference to the accompanying drawings which do not limit the scope and ambit of the invention. The description provided is purely by way of example and illustration.

The present invention envisages a system and method which provides for extraction and consolidation of unstructured data contained in a plurality of files in composite formats. The present invention is adapted for extracting and consolidating unstructured data that has been created in any format. In prior systems only spreadsheets having identical configurations could be consolidated or aggregated. In contrast, the present invention provides an improved system and method wherein data available in any format and configuration may be aggregated. While the present invention is adapted for extracting and consolidating unstructured data contained in a plurality of files in virtually any format, in the discussions below, composite spreadsheets are shown as an example of one application of this invention.

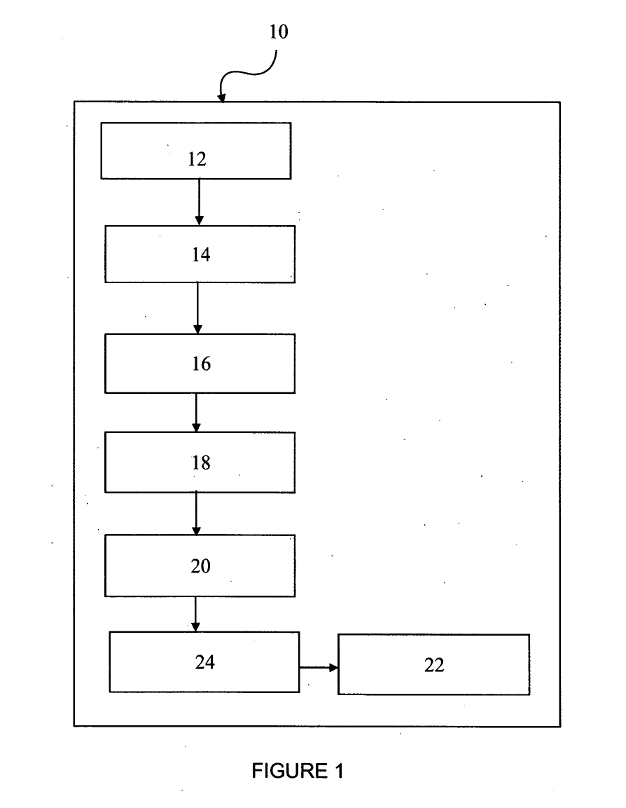

Referring to the accompanying drawings, FIG. 1 illustrates a block diagram of a system 10 that extracts and consolidates unstructured data contained in a plurality of files in composite formats. The system 10 in accordance with the present invention includes an input means denoted by the reference numeral 12 which receives plurality of input files containing unstructured data. The files received by the input means 12 can contain only tabular data or can contain tabular data along with other types of unstructured data including labels, captions, explanatory text, lists with predetermined values and the like.

The system 10, in accordance with the present invention, includes an extraction means denoted by the reference numeral 14. The extraction means cooperates with the input means 12 to receive the files from which the unstructured data needs to be extracted, analyzed and consolidated. The extraction means 14, in accordance with the present invention includes a natural language processing means (not shown in figures) which is adapted to process the files received by the extraction means 14. The natural language processing means in accordance with the present invention includes predetermined natural language processing heuristics. The natural language processing means processes the input files using predetermined natural language processing heuristics and identifies additional attributes corresponding to the unstructured data contained in received files. The extraction means 14, in accordance with the present invention further includes a spatial pattern recognition means (not shown in figures). The spatial pattern recognition means includes spatial pattern recognition heuristics. The spatial pattern recognition means recognizes the underlying pattern of the unstructured data contained in the received files based on the spatial pattern recognition heuristics.

Typically, data is stored in a data file in the form of structures. A structure is an array of cells wherein individual cells store individual data items. A structure essentially represents a group of contiguous non empty cells. But a structure also includes blank rows and blank columns which are inserted in the structure for improving the appearance and readability of data. In accordance with the present invention, the spatial pattern recognition means recognizes the layout of the unstructured data and ignores such empty rows and columns. The natural language processing means deciphers the textual contents that specify the attributes corresponding to the unstructured data contained in the received files. Deciphering the textual contents of the file helps in characterization of unstructured data. The textual contents included in a data file include title of the data file, name of the author, date of preparation of data, consumer name and the like. For example, if the received file contains a table and the title of the table is “Financial Results in Rupees Crores for Q1”, the natural language processing means characterizes the unstructured data contained in the table as corresponding to Financial Results of First Quarter and treats the numeric data as being represented in terms of crores of rupees.

In accordance with the present invention, the natural language processing means determines whether a particular cell in the received file contains any data or not. If a particular cell in the received file is found to contain data, the spatial pattern recognition means, in accordance with the present invention, associates metadata with that particular cell. The spatial pattern recognition means further associates metadata with every non empty cell i.e., cells that contain data. Metadata is structured data which describes the contents that are stored in a particular cell in a table. The spatial pattern recognition means processes every cell available in the received file and analyzes the user defined formulae contained in cells. The relationship between the columns that have been included in or used by the user defined formulae are also analyzed and stored for further utilization during consolidation of structured data. The empty rows and columns contained in the received file are ignored during consolidation because there is no metadata associated with the empty cells of the file.

In accordance with the present invention, the extraction means 14 extracts the unstructured data identified by the spatial pattern recognition means. The extraction means 14 extracts the unstructured data present in data files irrespective of the format of the data file. The data files from which the extraction means 14 can extract the unstructured data includes, but is not restricted to MS-Word workbook, MS-excel Spreadsheet, Lotus Spreadsheet, HTML (Hyper Text Markup Language) files and Adobe PDF document.

In accordance with the present invention, the conversion means 16 receives the unstructured data that has been extracted by the extraction means 14. The conversion means converts the extracted, unstructured data into either a user defined custom format or a native format thereby providing the extracted data with a well defined structure and format. The conversion means 14 converts the unstructured data into a structured form thereby producing structured data. The structured data could be present in formats including, but not restricted to relational data format, system defined XML (extensible markup language) format, user defined XML format, OWL (web ontology language) format, relational data format and XBRL (extensible business reporting language) format.

The structured data which is produced by the conversion means 16 is further worked on by an interlinking means denoted by reference numeral 18, which provides an interconnection between the various accessible sections of the structured data by creating interlinks between the various accessible sections of the structured data. The interlinking means 18 produces interlinked structured data by interlinking relevant accessible sections of the structured data.

In accordance with the present invention, there is provided a data aggregation means denoted by reference numeral 20 which receives the interlinked structured data from the interlinking means 18. The interlinked structured data could be available within a single file or contained in a plurality of files. In the case of interlinked structured data being available across a plurality of files, the data aggregation means 20 receives the plurality of files containing interlinked structured data from the interlinking means 18 and aggregates the interlinked structured data thereby producing unified structured data. The data aggregation means 20 aggregates the interlinked structured data based on the semantic analysis of data labels, explanatory text, captions, lists with predetermined values and the like associated with the interlinked structure data. The unified structured data produced by the data aggregation means 20 is stored in database 24. The unified, structured data stored in the database 24 can be extracted from the database 24 in formats including, but not restricted to system defined XML (extensible markup language) format, user defined XML format, OWL (web ontology language) format, relational data format and XBRL (extensible business reporting language) format.

In accordance with the present invention, there is provided a data model creation means (not shown in figures) which works on the unified structured data stored in the database 24 and creates a logical, structured data model representing the unified structured data. The unified, structured data contained in the database 24 is converted into a logical, structured data model regardless of the format of the unified, structured data. The logical, structured data model can also be stored as a persistent model for further usage. The logical, structured data model created by the data model creation means can also be viewed by the user. The unified, structured data represented by the logical, structured data model is extracted into a single data file in a format specified by the user. The user has the choice of deciding the format in which the unified structured data has to be extracted on to a data file. The unified structured can be extracted from the logical structured data model and presented to the user in formats including, but not restricted to system defined XML (extensible mark up language) format, user defined XML format, OWL (web ontology language) format, relational data format and XBRL (extensible business reporting language) format.

In accordance with the present invention, there is provided a display means denoted by the reference numeral 22 which is adapted to display the unified, structured data. The display means is adapted to retrieve the unified, structured data from the database 24. The display means 22 is adapted to display the unified structured data in formats including, but not restricted to system defined XML (extensible markup language) format, user defined XML format, OWL (web ontology language) format, relational data format and XBRL (extensible business reporting language) format.

In accordance with the present invention, there is provided a query interfacing means (not shown in figures) which receives queries corresponding to the unified structured data stored in the database 24. The query interfacing means works on the structured data to solve the received queries and displays the results corresponding to the received queries.

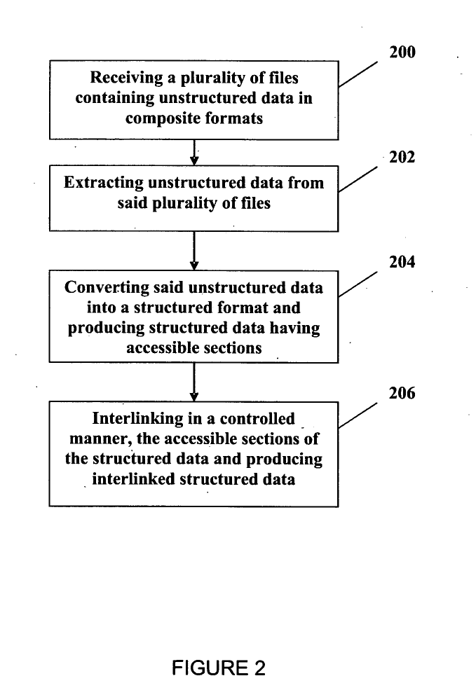

Referring to FIG. 2, a method for extracting unstructured data contained in a plurality of files in composite formats is illustrated through a flow diagram. The method envisaged by the present invention includes the following steps:
receiving a plurality of files containing unstructured data in composite formats 200;
extracting unstructured data from said plurality of files 202;
converting said unstructured data into a structured format and producing structured data having accessible sections 204; and
interlinking in a controlled manner, the accessible sections of said structured data and producing interlinked structured data 206.

In accordance with the present invention, the method for extracting and consolidating unstructured data contained in a plurality of files in composite formats further includes the step of aggregating in a controlled manner, the interlinked structured data. The method for extracting and consolidating unstructured data contained in a plurality of files in composite formats also includes the step of receiving queries corresponding to the interlinked structured data, working on said interlinked structured data to solve received queries and displaying the results corresponding to the received queries.

In accordance with the present invention, the method for extracting unstructured data contained in a plurality of files in composite formats further includes the step of storing the unified, structured data in a database which is denoted by reference numeral 24 in FIG. 1.

In accordance with the present invention, the method for extracting the unstructured data contained in a plurality of files in composite formats further includes the step of displaying the unified, structured data through a display means denoted by the reference numeral 22 in FIG. 1.

In accordance with the present invention, the step of extracting unstructured data from the plurality of files, denoted by the reference numeral 202 further includes the step of analyzing the unstructured data using predetermined natural language processing heuristics. The step of extracting unstructured data from the plurality of files, denoted by the reference numeral 202 further includes the step of recognizing the layout of the unstructured data using predetermined spatial pattern recognition heuristics. The step of converting the unstructured data into a structured format, denoted by the reference numeral 204 further includes the step of converting the unstructured data into a generalized native format such as system defined XML (extensible markup language) format and relational data format. Alternatively, the unstructured data can also be converted into custom user defined format including user defined XML format and user defined XBRL (extensible business reporting language) format.

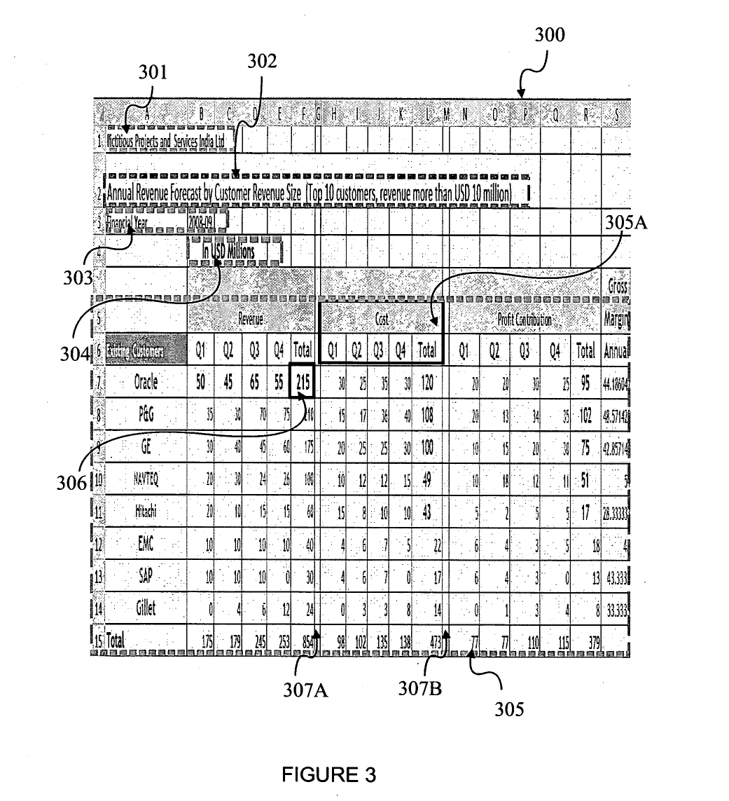

Referring to FIG. 3, there is provided a composite spreadsheet denoted by the reference numeral 300 that includes five distinct structures. The five distinct structures have been demarcated by rectangles that are denoted by reference numerals 301, 302,303,304 and 305 respectively. The first rectangle denoted by the reference numeral 301 includes the title of the composite spreadsheet. The origin of the unstructured data contained in the composite spreadsheet is determined by analyzing the title of the composite spreadsheet. The second rectangle denoted by the reference numeral 302 includes the title of the table that is carrying the unstructured data. The title of the table is utilized to characterize the unstructured data stored in the composite spreadsheet. The exemplary spreadsheet 300 may contain the title “Annual Revenue Forecast by Customer Revenue Size (Top 10 Customers, revenue more than USD 10 million)”. The system 10 in accordance with the present invention includes a natural language processing means (not shown in figures) that processes the title associated with the composite spreadsheet. Using predetermined natural language processing heuristics, the title of the spreadsheet and the logic underlying the arrangement of data items in the spreadsheet is determined, i.e., it is determined that the composite spreadsheet contains unstructured data that corresponds to only top ten customers. The system 10, in accordance with the present invention includes a spatial pattern recognition means which makes use of predetermined spatial pattern recognition heuristics to determine the layout of arrangement of the unstructured data. The third triangle 303 includes an indication to the year to which the unstructured data corresponds. The fourth rectangle 304 includes the unit of measurement used to measure the unstructured data and in composite spreadsheet 300, the unstructured data is provided in terms of millions of United States Dollars (USD).

The fifth rectangle 305 includes financial categories, namely “revenue”, “cost” and “profit contribution” which are represented as labels in the composite spreadsheet 300 and the unstructured data corresponding to those categories. Each of the financial categories is associated with specific time intervals across which the unstructured data is distributed. For example, the time intervals for each financial category are represented as data labels Q1, Q2, Q3 and Q4. These divisions are represented on the horizontal axis of the composite spreadsheet 300 and are demarcated by the rectangle denoted by reference numeral 305A. The natural language processing means processes the textual description included in fifth rectangle 305A and determines that the unstructured data contained in the composite spreadsheet is distributed across four intervals, namely Q1, Q2, Q3 and Q4. The column “TOTAL” present on the horizontal axis of the composite spreadsheet 300 and denoted by the reference numeral 306 stores the total of values represented as Q1, Q2, Q3 and Q4. The values corresponding to the field “TOTAL” are calculated using the formula ‘Q1+Q2+Q3+Q4’.

In accordance with the present invention, the formula (Total=Q1+Q2+Q3+Q4) associated with the column “TOTAL” and the relationship between the data labels “TOTAL”, “Q1”, “Q2”, “Q3” and “Q4” is deciphered by the analysis of the regular expression “Total=Q1+Q2+Q3+Q4”. The relationship between the above mentioned data labels is stored by the system 10 and is further utilized during the step of aggregating the data contained in composite spreadsheets. The empty spaces in the composite spreadsheet 300, denoted by reference numeral 307A and 307B are recognized by the spatial pattern recognition means. Since these arrays of cells, denoted by reference numeral 307A and 307B do not contain any data, the spatial pattern recognition means ignores the empty cells. The spatial pattern recognition means identifies unstructured data contained within the spreadsheet 300 based on the semantic analysis carried out using pre determined spatial pattern recognition heuristics. The extraction means which is denoted by reference numeral 14 in FIG. 1 extracts the unstructured data that has been identified by the spatial pattern recognition means. The unstructured data so extracted by the extraction means 14 is communicated to the conversion means which is denoted by reference numeral 16 in FIG. 1.

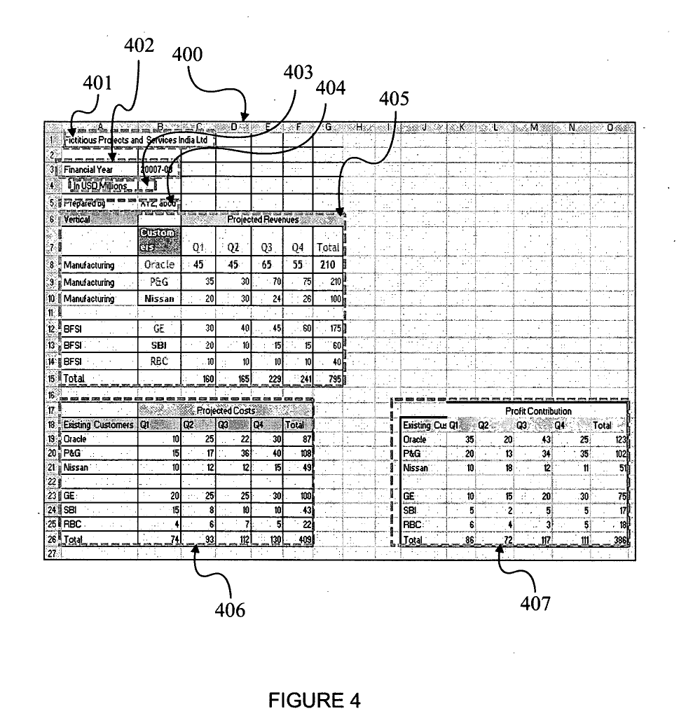

Referring to FIG. 4, there is provided another composite spreadsheet denoted by reference numeral 400 that includes seven distinct structures. The seven distinct structures are demarcated by rectangles and the rectangles are denoted by reference numerals 401, 402, 403, 404, 405, 406 and 407 respectively. The first rectangle demarcating the first structure and denoted by the reference numeral 401 includes the title of the composite spreadsheet containing unstructured data. The second rectangle demarcating the second structure and denoted by the reference numeral 402 includes the reference to the financial year for which the unstructured data was prepared. The third rectangle demarcating the third structure and denoted by the reference numeral 403 includes the unit of measurement used to measure the unstructured data. The fourth rectangle demarcating the fourth structure and denoted by the reference numeral 404 includes the name of the author. The unstructured data contained in four rectangles namely 401, 402, 403 and 404 is semantically analyzed by the spatial pattern recognition means. The unstructured data contained in the first rectangle 401 is characterized to be the name of the company to which the unstructured data is related. The unstructured data contained in the second triangle 402 is characterized to be corresponding to the financial year for which the unstructured data was related. The unstructured data contained in third rectangle 403 is characterized to be corresponding to the unit of measurement used to measure the unstructured data and the unstructured data contained in fourth rectangle 404 is characterized to be corresponding to the name of the person who compiled the unstructured data. When the spatial pattern recognition means semantically analyzes the structures demarcated by the rectangles 405, 406 and 407, it determines that the data contained in the three rectangles 405, 406 and 407 corresponds to the financial data of the company whose name was deciphered by semantic processing of rectangle 401. Further, the data contained in the three rectangles 405, 406 and 407 is semantically processed using predetermined spatial pattern recognition heuristics. The extraction means denoted by reference numeral 14 in FIG. 1 extracts the unstructured data that has been identified by the spatial pattern recognition means. The unstructured data so extracted by the extraction means is communicated to the conversion means 16 denoted by the reference numeral 16 in FIG. 1.

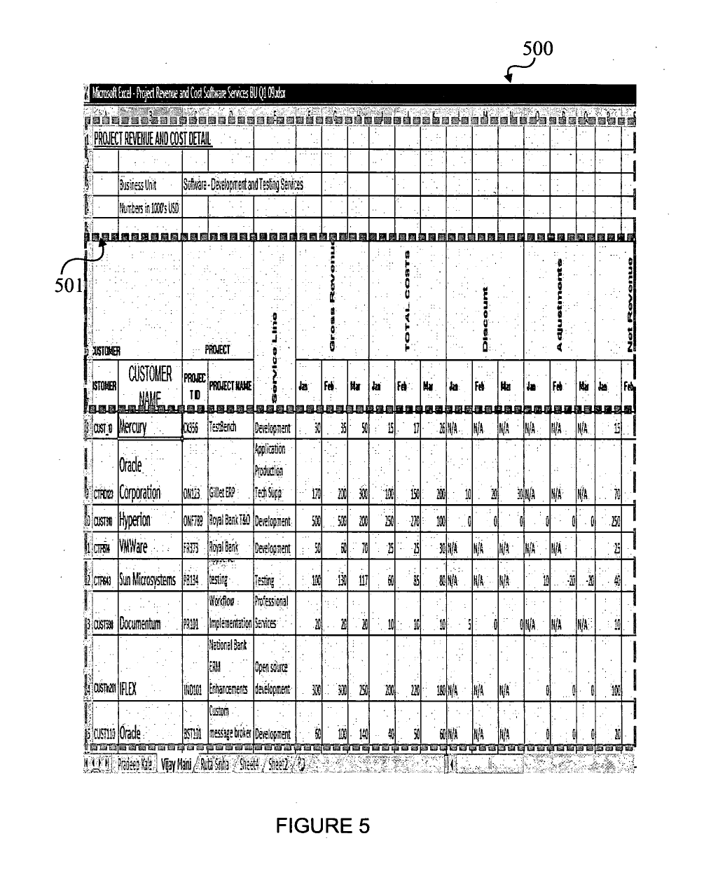

Referring to FIG. 5, there is provided yet another composite spreadsheet denoted by reference numeral 500. The composite spreadsheet 500 contains a collection of arbitrary structures and the unstructured data contained in those arbitrary structures is represented using multiple data labels. The grouping of data labels has been demarcated by a rectangle denoted by the reference numeral 501. The spatial pattern recognition means, in accordance with the present invention, analyzes the data labels available within the spreadsheet 500 and identifies unstructured data contained within the spreadsheet 500 based on spatial pattern recognition heuristics. The extraction means extracts the unstructured data that has been identified by the spatial pattern recognition means. The unstructured data so extracted by the extraction means 14 is communicated to the conversion means which is denoted by the reference numeral 16 in FIG. 1. The conversion means receives a plurality of files containing the unstructured data from the extraction means and converts the unstructured data into a user defined format or a generalized native format depending upon the requirements of the user.

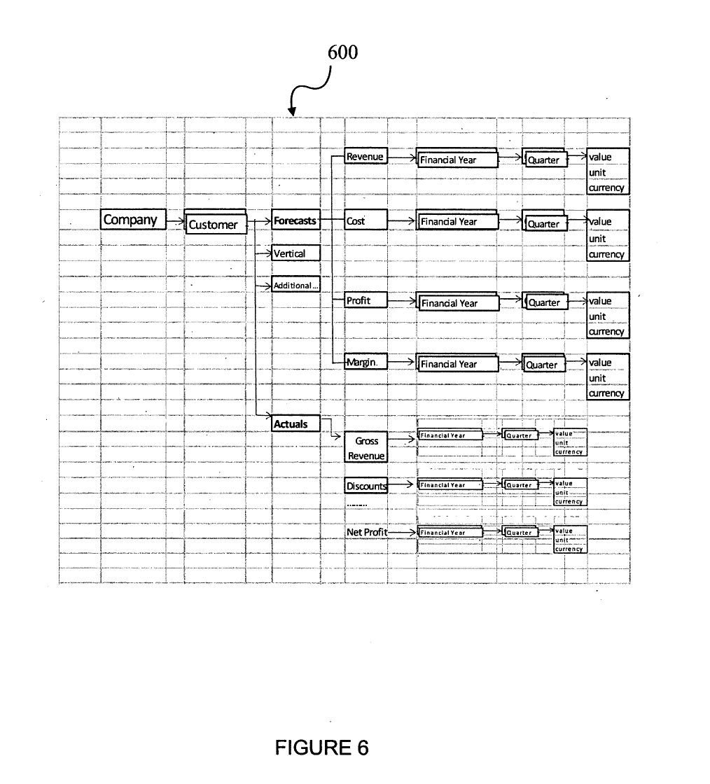

Referring to FIG. 6, there is shown a logical, structured data model denoted by reference numeral 600 which has been generated by the data model creation means. The logical, structured data model provides a unified and meaningful representation of the data that was previously contained in composite and arbitrarily structured formats in composite spreadsheets 300, 400 and 500. The logical, structured data model 600 can also be viewed by the user. The unified, structured data represented by the logical, structured data model is made available to the user in the form of a single file and in a format chosen by the user. The user can choose to extract the unified, structured data in formats including, but not restricted to system defined XML (extensible markup language) format, user defined XML format, relational data format, OWL (web ontology language) format and XBRL (extensible business reporting language) format. The unified, structured data gets stored in database 24 and it can be retrieved from the database 24 in formats including but not restricted to system defined XML (extensible markup language) format, user defined XML format, relational data format, OWL (web ontology language) format and XBRL (extensible business reporting language) format.

### TECHNICAL ADVANCEMENTS

The technical advancements of the present invention include the following:
the present invention envisages a system that automatically detects data structures corresponding to the data embedded in composite spreadsheets;
the present invention envisages a system that automatically detects data structures corresponding to the data embedded in data files including PDF files, HTML files and the like;
the present invention envisages a system that makes no assumptions but concrete analysis of the format, layout and content of composite spreadsheets;
the present invention provides a system that associates metadata with each non empty cell contained in the composite spreadsheet;
the present invention envisages a system that identifies hierarchical relationships between the unstructured data based on natural language processing heuristics;
the present invention envisages a system that identifies the layout of unstructured data based on spatial pattern recognition heuristics;
the present invention provides a system that processes all the information available in the composite spreadsheet including filters, cross sheet references, cross file references, captions and comments;
the present invention envisages a system that automatically extracts unstructured data contained in different files in discrete and composite formats;
the present invention provides a system that converts the unstructured data into a structured format;
the present invention envisages a system that provides for conversion of unstructured data into multiple formats including system defined XML (extensible mark up language) format, user defined XML format, relational data format and OWL (web ontology language) format;
the present invention provides a system that can be used as a light weight in memory data store containing a collection of composite spreadsheets which in turn contain unstructured data; and
the present invention envisages a system that aggregates the structured data based on the data type associated with the structured data.

While considerable emphasis has been placed herein on the components and component parts of the preferred embodiments, it will be appreciated that many embodiments can be made and that many changes can be made in the preferred embodiments without departing from the principles of the invention. These and other changes in the preferred embodiment as well as other embodiments of the invention will be apparent to those skilled in the art from the disclosure herein, whereby it is to be distinctly understood that the foregoing descriptive matter is to be interpreted merely as illustrative of the invention and not as a limitation.

1. A system for extracting and consolidating unstructured data contained in a plurality of files in composite formats, said system comprising:
input means adapted to receive a plurality of files containing unstructured data in composite formats;
extraction means adapted to receive said plurality of files, said extraction means adapted to extract said unstructured data from said plurality of files;
conversion means adapted to receive said unstructured data, said conversion means further adapted to convert said unstructured data into a structured format and produce structured data having accessible sections; and
interlinking means adapted to work on said structured data, said interlinking means further adapted to interlink in a controlled manner, said accessible sections of said structured data and produce interlinked structured data.

2. The system as claimed in claim 1, wherein said system further includes a data aggregation means adapted to work on said interlinked structured data, said data aggregation means further adapted to aggregate in a controlled manner, said interlinked structured data.

3. The system as claimed in claim 1, wherein said system further includes a query interfacing means adapted to receive queries corresponding to said interlinked structured data, said query interfacing means further adapted to work on said interlinked structured data to solve received queries and display the results corresponding to said received queries.

4. The system as claimed in claim 1, wherein said extraction means includes a natural language processing means having predetermined natural language processing heuristics, said natural language processing means adapted to analyze said unstructured data contained in said plurality of files.

5. The system as claimed in claim 1, wherein said extraction means includes a spatial pattern recognition means having predetermined pattern recognition heuristics, said spatial pattern recognition means adapted to recognize the pattern of said unstructured data contained in said plurality of files.

6. The system as claimed in claim 1, wherein said conversion means is adapted to convert said unstructured data into a generalized native format.

7. The system as claimed in claim 1, wherein said conversion means is adapted to convert said unstructured data into a user defined format.

8. A method for extracting and consolidating unstructured data contained in a plurality of files in composite formats, said method comprising the following steps:
receiving a plurality of files containing unstructured data in composite formats;
extracting unstructured data from said plurality of files;
converting said unstructured data into a structured format and producing structured data having accessible sections; and
interlinking in a controlled manner, the accessible sections of said structured data and producing interlinked structured data.

9. The method as claimed in claim 8, wherein the method for extracting and consolidating unstructured data contained in a plurality of files in composite formats further includes the step of aggregating in a controlled manner, said interlinked structured data.

10. The method as claimed in claim 8, the method for extracting and consolidating unstructured data contained in a plurality of files in composite formats further includes the step of receiving queries corresponding to said interlinked structured data, working on said interlinked structured data to solve received queries and displaying the results corresponding to said received queries.

11. The method as claimed in claim 8, wherein the step of extracting said unstructured data from said plurality of files further includes the step of analyzing said unstructured data using predetermined natural language processing heuristics.

12. The method as claimed in claim 8, wherein the step of extracting said unstructured data further includes the step of recognizing the pattern of said unstructured data using predetermined spatial pattern recognition heuristics.

13. The method as claimed in claim 8, wherein the step of converting said unstructured data into a structured format further includes the step of converting said unstructured data into a generalized native format.

14. The method as claimed in claim 8, wherein the step of converting said unstructured data into a structured format further includes the step of converting said unstructured data into a user defined format.
